(19) United States
(12) Patent Application Publication
(10) Pub. No.: US 2013/0091204 A1
(43) Pub. Date: Apr. 11, 2013

(54) System and method of integrating various platforms and methods of using the same

(71) Applicants: Joheem Loh, San Jose, CA (US); Randall Eike, San Jose, CA (US)

(72) Inventors: Joheem Loh, San Jose, CA (US); Randall Eike, San Jose, CA (US)

(21) Appl. No.: 13/136,855

(22) Filed: Aug. 12, 2011

Related U.S. Application Data
(60) Provisional application No. 61/373,024, filed on Aug. 12, 2010.
(60) Provisional application No. 61/449,075, filed on Mar. 3, 2011.
(60) Provisional application No. 61/495,383, filed on Jun. 10, 2011.

(51) Int. Cl. H04L 29/06

(52) U.S. Cl. CPC H04L 65/403
USPC 709/204

(57) ABSTRACT

The present invention relates generally to systems and methods of integrating various platforms and streams, including social platforms and streams as well as networking, customer management, targeted marketing, and enterprise operations relating to the systems and methods. The present invention also includes methods of using the above integration, networking, publishing aggregation, marketing and enterprise solutions.

### CROSS-REFERENCE TO RELATED APPLICATIONS

This application is a non-provisional patent application of U.S. Provisional Patent Application 61/373,024, filed on Aug. 12, 2010 and U.S. Provisional Patent Application 61/449,075, filed on Mar. 3, 2011 and U.S. Provisional Patent Application 61/495,383, filed on Jun. 3, 2011, all of which are incorporated by reference in their entirety and priority to which is fully claimed.

### FIELD OF THE INVENTION

The present invention relates generally to systems and methods of integrating various platforms and streams, including social platforms and streams as well as networking, customer management, targeted marketing, and enterprise operations relating to the systems and methods.

The term “SOCXS” (or “Socxs”) as used herein is a brand name for one or more embodiments of the present invention and, as also used herein, can refer to the general overall system and capabilities of the present invention or also to individual aspects or embodiments of both the overall system or aspects of the present invention.

### DETAILED DESCRIPTION

There are a wide variety of social networks available to users and organizations on the Internet. A social network is a network that fosters users community interactions and information sharing. Often, there is more to these networks than conversation exchanges. In addition, there are a wide variety of platforms for each of these social networks. Social networking websites are becoming increasingly popular. Examples of social networking platforms include Facebook, Twitter, YouTube, Flickr, Picasa, Digg, RSS, Blogs, Reddit, Linkedln, Wikipedia, MySpace, iPhone, Andoroid, etc. Furthermore, social networks can include any other webpage, application, or any other platform on the Internet that is used by any organization or user to communicate to its users.

According to some embodiments of the present invention, systems and methods are presented that aggregate and publish content of an organization or user across a wide variety of social networking platforms. According to other embodiments of the present invention customer management, targeted marketing, and enterprise operations systems and methods relating to the media aggregation and publication systems, including Socxs systems are provided.

The following term descriptions are illustrative and may apply in certain embodiments of Socxs system examples described in this application or claimed.

Social Network Any website that fosters user community interactions and information sharing that is not limited to conversation exchanges. Some examples, Facebook, Twitter, YouTube, Flickr, Picasa, Digg, RSS, Blogs, Reddit, LinkedIn, Wikipedia, MySpace, iPhone, Android, etc.

Media: Any piece content whether text, still images, or videos, such as comments, posts, messages, blogs, news, articles, stories, photos, videos, etc.

Social Media Any media that is shared over social networks.

Subject: It is a superset of all topics, encompassing every issue from the individual to business, corporation, news, event, entertainment, sports, games, community, etc.

Users: A user could be any entity making use of the Socxs system, from individual to corporation, organization, entertainer, artist, athlete, etc.

Social Exchange It is a place (or network) where social media from across disparate social networks are exchanged and aggregated. The Social Exchange System essentially brings social media, users, and social networks together for any subject matter.

Stream: A stream is the flow of social media from a particular social network.

Page: A page is representation of the media made available across the Channels.

Module or Widget: A module or widget is a component of a page.

Channel: The Socxs technology (pages, functionalities, and anything that Socxs creates) is available via different ‘Channels’. These Channels are:
Web: Available on any web browser
App: Available as apps on devices, such as iPhone, Android, TV, book readers, gaming system, Blackberry, and any other third party devices on the market today and not yet on the market.
Mobile: Available on web browsers of mobile devices
Facebook: Added to Facebook
Widgets: Embedded as web widgets anywhere

### BRIEF DESCRIPTION OF THE FIGURES

FIG. 1 shows aspects of an example of a method of aggregating and publishing media according to certain embodiments of the present invention

FIG. 2 shows an example of an interactive user screen according to aspects of an embodiment of the present invention.

FIG. 3 shows a block diagram of steps of a Socxs media pull from an exemplary social page.

FIG. 4 shows a block diagram of a file synchronization system according to embodiments of the present invention.

FIG. 5 shows a chart of certain feature definitions and specifications according to an embodiment of the present invention relating to a data caching system in a Socxs implementation.

FIG. 6 shows an overview of certain aggregation and publication processes according to an embodiment of the present invention.

FIGS. 7a and 7b show an example of screen shots according to an embodiment of the present invention.

FIGS. 8a and 8b show an example of screen shots according to an embodiment of the present invention.

FIG. 9 shows an example of a workflow of a CMS system.

Aspects of the present invention comprise a novel a Social Exchange System that enables social media for any subject matter to be exchanged easily across social networks for all users. Socxs initially was a name to stand for Social Xchanges.

Aspects of the present invention are illustrated by the following examples of non-limiting embodiments of the invention. The invention can, without limitation, comprise aspects of methods, software, hardware, media networks, internet use, and user input. In some examples a system such as a Socxs system described below can comprise software or software services operated on a server and accessed by users either directly or via the internet. In some examples a user can use Socxs systems and software to create a LiveEvent or Supersite or other Socxs account that can be hosted privately, by an enterprise, or by a Socxs provider, including a service hosted on the cloud. In some embodiments a Socxs user can by the use of the Socxs account identify, aggregate, customize, filter and publish data, media, systems and other information over public or private networks. In some embodiments enterprises can sponsor, host, or monitor LiveEvent or supersites in conjunction with marketing, advertising, customer management, public relations or other enterprise interests or activities.

### Example 1

One embodiment of a Socxs System comprises the following features, capabilities and aspects.

In this Example 1 the Socxs exchange can create a live repository, which is a Social Destination page in some embodiments termed a LiveEvent (as well as termed a Supersite in other embodiments), of a group of or all selected social exchanges for a subject matter.

SOCXS Users and their fans (basically anyone) will be able to contribute media to any LiveEvent, effectively creating a Live Stream of a subject matter that is simultaneously being:
Pushed out to the various social networks, and
Pulled into the Socxs LiveEvent Channel
The Socxs system of this example provides a Social CMS (Social Content Management System):
   Socxs provides a dashboard, called MediaGate, to allow anyone (even non-technical users) to create their Social Destination page—the LiveEvents—on the various Channels described above.
   In a few steps using simple user interface, users will be able to manage their social media and users for any subject matter all in one convenient location.
   Users can fully customize their page without doing any software programming.
Aggregate:
   User specify a ‘collective streams’, which become the base collection.
   Socxs aggregate the social media streams automatically based on the collective streams.
Authenticate:
   Manage authentication collectively across users' aggregated streams to all their social networks.
Pull:
   Pull social content as ‘streams’ from social networks into modules that can be displayed on the Channels.
   Each Channel can have any number of these modules
   Each module can have any number of streams
   Each module can have a combination of different streams from different social networks, based on the type of content
Post:
   Socxs enables users and their fans (basically anyone) to post back to the collective streams across the many social networks from one place.
Socxs Tag:
   The system adds a special Socxs tag to each piece of media to enable the system to easily discover the media across the various social networks.
Track:
   The system tracks the collective social activities from across the many streams in the many social networks all into one convenient location.
   Social activities are stats such as number of posts, comments, messages, file uploads, etc.
Stream Lookup (Stream Discoverer):
   By URL: We provide a simple method to add streams into the system. User specifies only the URL and the system automatically finds the stream and adds it.
   By Bookmarklet: A bookmarklet enabling the discovering and adding of streams into the system in real time while browsing on the social networks.
   By Keywords: Users enters a keyword or list of keywords and the system finds the streams on the social networks based on these keywords.
Customize:
   Customization:
      Users can fully customize their page—layout, colors, skins, and content.
   Free form module
      To allow users to create non-social content module. This can be text, html, graphs, flash or any other type of content. It can also be social media such as YouTube embed videos and LinkedIn relationships from other sites or services that only provide limited access to information.
   Layout:
      Point, click, drag and drop to add/delete modules and change module placement, layout, and size
   Skins:
      Simple UI to change the page and module colors
      Simple upload to add background image
   Unique templating system that allows more advanced users to specify data structure, content type, styles for each module
Publish:
   Push out (publish):
      Customized page (Socxs LiveEvents) are push out for public viewing.
   Simple UI:
      Point and click to publish it out.
   Preview:
      Changes that are made are not available for public viewing (only as private) until the user click on the publish button.
      This allows changes to be reviewed before they are pushed out.
   Private vs. Public
      The entire LiveEvent can be turned on and off for public and private viewing respectively.
      When the public is turned off, it is effectively private site for internal use.
      Private site requires login access.
   Search Engine Optimized:
      Each Socxs LiveEvent is optimized so it's easy for search engines to crawl and index.
Workflow:
   Schedule:
      Schedule posts
      Schedule publishes
   Alert:
      Alert users when specified triggers are activated:
         by traffic
         by keywords
         by events
   Monitor:
      Monitor the buzz/sentiment about a brand, product, interest, etc based on specified parameters
   Filter:
      Filters out streams based on provided keywords
   Combo:
      Combine the above workflow elements to create more sophisticated business rules, such as a ‘monitor’ with an ‘alert’
Unified User Profile:
   Identify and map the users across the social networks.
   Example, if he's ‘Kratos’ at Google, Socxs can map him to ‘John Smith’ on Facebook, ‘ilikegames’ on Twitter, etc, building out a Unified User Profile for that particular user.
      Also, instead of referencing the Socxs technology as bringing the pages, functionalities, etc. only to the web, we should define it so they are available on all Channels described in the definition.

A. Terminology
MediaGate
   It's the technology that allows users to define their social media streams and create Social Destination page called LiveEvents, provided by Socxs Technologies Inc. (“Socxs”)
LiveEvents (or Supersites) & Super Communities
   We have yet to decide on whether to use LiveEvents or Supersites or Social Supersites to represent the pages created by Socxs.
   A ‘LiveEvents’ (or ‘Supersites’ or ‘Social Supersites’) are Social Destinations made available by Socxs technologies across the above described Channels to represent a subject (a social view) that is an aggregation of content from the many social networks as well as other publicly available sources of content.
   A ‘Super Community’ is the user base from across multiple social networks that Socxs brings together as a single unified profile or community view.
Socxs Live
   This is the version of Socxs available via the App Channel.
Mikey Socxsmonkey & Mikey Socxsmonkey Comic
   The monkey shown below is a personality to represent Socxs.
   There is also a comic strip that Socxs publishes.
‘AnyAppWhere’ for ‘Anyone-to-Anything-to-Anywhere’
   We are coining the term ‘AnyAppWhere’ as Socxs is a media exchange system reaches across social networks.
   It enables a many-to-one publishing around a subject or subjects.
   It then flips the process, enabling a one-to-many viral distribution of Supersites.
   It's essentially an ‘AnyAppWhere’ for making ‘Anyone-to-Anything-to-Anywhere’ happen so that social campaigns are ‘Live, Viral & Relevant.’
Search Collections'
   The Socxs technology creates a page that is an aggregation of Searches and their results across all social networks, publicly available content and search engines.
‘Media Connections’
   Socxs Media Connections create a page dynamically from the relationships in Facebook Social Graph.
‘Anything You-Want’
   An ‘Anything-You-Want’ is defined as a hybrid page that is a combination of any the following:
      Customized pages and modules
      Socxs Search Aggregation
      Socxs Social Graph Pages

### Other Functionalities

All Socxs functionalities described in this doc will be made available for the Channels described in the Definition section above (and not just the web channel).

### B. Socxs Pages: ‘Search Collections’

Socxs technology creates an aggregation of Searches and their results across all social networks, publicly available content and search engines.

Essentially, it's as follows:
1. The Socxs technology provides the functionality to do a Socxs Search
2. A user enters the keywords to search/filter terms used by the Socxs Search
3. The Socxs technology enables the keyword search across all the different social networks and predefined relevant publicly available data
4. The Socxs technology then aggregates the search results
5. The MediaGate technology publishes back a page dynamically with the aggregated results of the search
   i. It's a new representation of search displayed in a Socxs page

### C. Socxs Pages: ‘Media Connections’

Socxs ‘Media Connections’ is a page, built dynamically from the relationships in Facebook Social Graph. A user could simply enter a Facebook page of interest and Socxs will create an aggregated page based on the relationships in the Facebook Social Graph. The Socxs technology will read a Facebook Social Graph and give the user a full representation of what the page will contain in terms of content, media, and with the modules fully aggregated.
1. User enters a Facebook page
2. Socxs reads the relationships within Facebook Social Graph
3. Socxs technology automatically builds a page that aggregates the content from all the sources within the Facebook Social Graph relationships.

### D. Socxs Pages: ‘Anything-You-Want’

‘Anything-You-Want’ page is a hybrid page that is a combination of any the following:
Customized pages and modules
Socxs Search Aggregation
Socxs Social Graph Pages

### E. Integrated Mobile Strategy

Automatically Generated
   It's basically a fully customized mobile version of the Socxs frontend page that is automatically generated with no extra work.
   It will be accessible from browser app of mobile devices
   Applications can be developed, to be downloaded onto iPhones, Android and other smart phones which enable mobile application to be accessed directly from an icon on a phone. These applications would launch Socxs pages.
Mobile Browser
   Auto detect the phone mobile browser and display the mobile version instead of the regular version
One module per screen per load
   Instead of displaying the current regular 1024 version all at once, break up the display one module at a time.
   Hence, at any point on the screen, there should only be one module displayed. Each screen is exactly the one module from the Socxs page.
Module size
   The size is optimized to fit into the mobile screen.

F. AnyAppWhere (Anyone-to-Anything-to-Anywhere'): Socxs Media SharingSocxs enables pages and modules to be shared easily. Socxs system automatically adds the sharing functionality to every Socxs page and module. All visitors to the Socxs page can share the content. I.E. even if they don't have MediaGate access to the page, they can still share the page content. Generally speaking, if the page is public, the page content can be shared.

This enables businesses to easily start a Social, Viral, and Click Marketing campaign, enabling ‘Anyone-to-Anything-to-Anywhere’, making the campaigns ‘Live, Viral, and Relevant’ . . . via Socxs ‘AnyAppWhere’.

Socxs can also capture the data and statistics when users share Socxs content. We will track the following:
Who is the user?
What did the user share?
What are the Source and Destination pages?
How many times the user shared the Socxs content?

The present exemplary embodiment comprises 3 ways for sharing page content via ‘AnyAppWhere’:
Page Info
   For sharing the page info in Facebook, Twitter, email, etc.
Modules
   The Socxs system automatically creates code for every module on the page.
   When visitors embed this code into their own website, it'll automatically recreate the module. This module is updated with live data every time the page is refreshed.
   This code is made available to visitors on a Socxs page and on each embedded module.
   The modules embedded into a non-Socxs domain are still fully functional and interactive as it would be on the Socxs page.
Facebook Tab
   A Facebook version is automatically created for each Socxs page in a few clicks.
   Any visitor to the Socxs page will be able to take the Facebook version of the Socxs page and add it as a Socxs Tab to their Facebook Page.
   The Socxs Tabs on Facebook are still fully functional and interactive as they would be on the Socxs domain pages.

### G. Socxs Social and Viral CRM

A new Socxs module type that enables capturing of CRM information about the user, profile, demographic, geographic, promotions, etc.
With media sharing the modules can be shared anywhere on anyone's page whether it's created by the page owner or not, whether on Socxs domain or non-Socxs domain.
These Socxs CRM modules can be critical in building a single unified profile for capturing user data across social networks on any pages they are embedded in.

1 New Module Types
The Socxs infrastructure is built to allow new modules types to be created easily.
Any new modules types created may automatically inherit the ‘AnyAppWhere’ functionality so that they can all be shared by anyone and anywhere.
Some examples of such modules are:
   Media (Video/Audio) Stream type
   Rating and Review module type
   Polling and Survey module type
   Sweepstakes module type
   Registration module type
   Social Graph module type
   Etc.
User Created Module Types Sharing:
   Socxs technology allows users to share any new module type created by users, adding to a library of user created modules.
   This library is an available resource of user created modules that everyone can grab and use in their Socxs pages.

### H. Game Destination

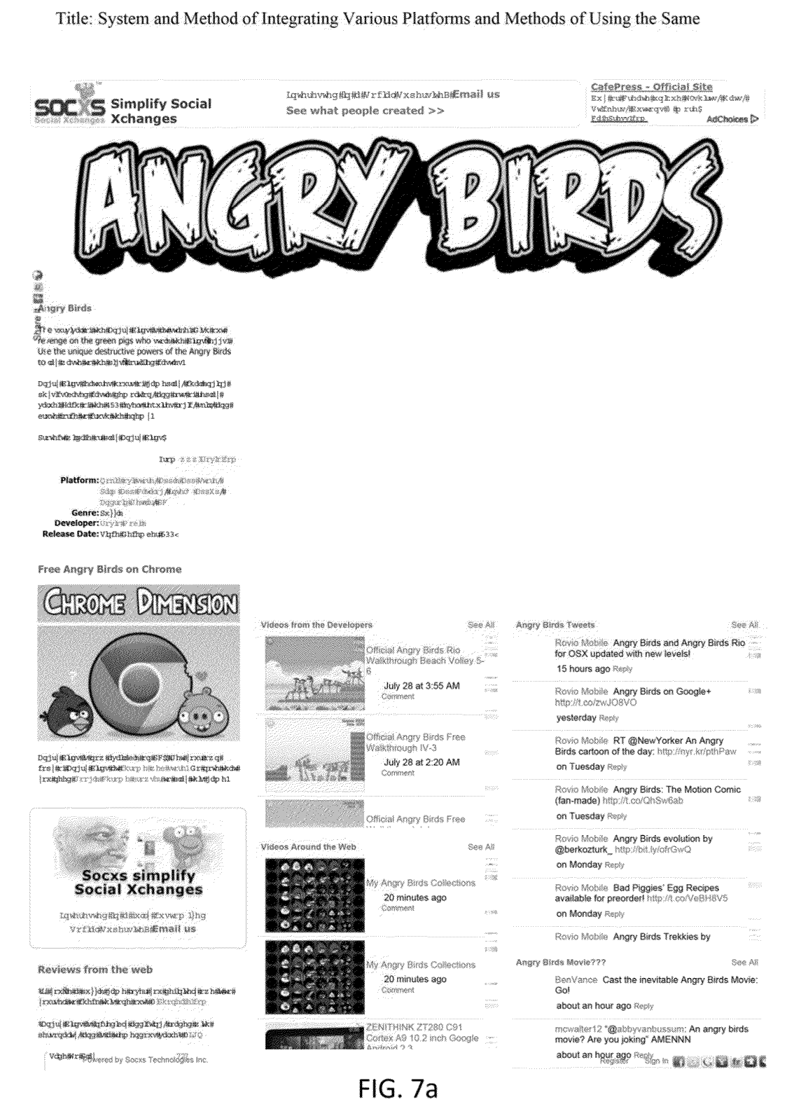

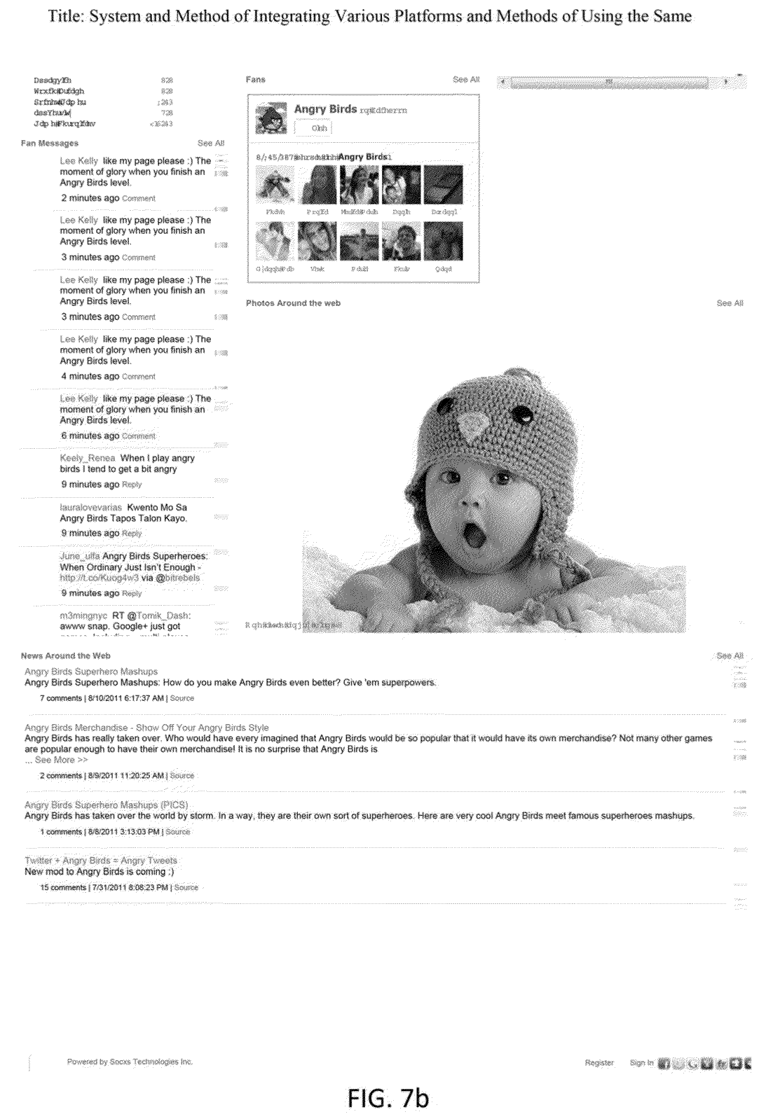

Using the Socxs platform destinations can be created for virtually all things gaming: game data, social media (messages, photos, videos, news, fans, blogs etc.), marketing messages, ads, and more.
Some examples include:
   http://www.socxs.com/social/AngryBirds
   http://www.socxs.com/social/Bejeweled3
   http://www.socxs.com/social/CityVilie
   http://www.socxs.com/social/dcuniverse
   http://www.socxs.com/social/LBP2
   http://www.socks.com/social/dukenukemforever
   http://www.socxs.com/social/Farmville
   http://www.socxs.com/social/Reach
   http://www.socxs.com/social/rockband3
   http://www.socxs.com/social/SuperMeatBoy
   http://www.socxs.com/social/WorldofTanks
Screen shots of some of the above exemplary Socxs destinations are shown in FIGS. 7a to 7n attached to the instant application.

### I. Bringing It All Together

It's the infrastructure that brings it all together:
The present embodiment enables the building of pages with MediaGate using an interface as ‘Simple as Search’
   MediaGate technology for business users
   Simplify the content publication process, publish content from one place
   Fully customizable corporate websites that bring live interesting relevant content back for consumers to see. It makes the corporate site the place to see all social content, in one place.
   Modular platforms that enables new module types to be created and shared
Add to Facebook:
   The pages can be automatically added into Facebook.
Social Aggregation
   Aggregate any media stream from any social network (such as Facebook, Twitter, YouTube, Digg, Blogger, Flickr, Picasa, etc.) around any issue,

subject,
Mobile Version:
   Mobile pages may be automatically optimized for small footprint smartphones
AnyAppWhere:
   Pages can be instantly added onto Facebook
   Modules are
Social CRM
   Create a single unified social user profile from all the social networks:
   Social CRM modules to capture demographic, geographic, consumer interests, and more . . . .
      The present invention enables creative marketing strategies:
Consistent Brand and Social Experience
Social & Viral CRM Campaigns
Social Direct Marketing
Social Promotions
Social Coupon Marketing
Social Pyramid Marketing
Social Sweepstakes
Cross Social Network Applications
Click Campaigns
Live, Viral & Relevant Marketing: Anyone-to-Anything-to-Anywhere

### II

### III. Example 2

Example 2 contrasts a potential non-Socxs enabled enterprise campaign manager with the functionality provided the same manager utilizing aspects of embodiments of the present invention.

A non-Socxs enabled campaign manager of the Enterprise must monitor, post, and manage each individual social network (to be monitored) separately. Each piece of media lives separately on the social network and the campaign manager will have to access and track the media from each social network separately. Socxs unifies the disparate social networks and all the media into a unified social exchange. Within this social exchange, the campaign manager will be able to manage the disparate social networks as one aggregated exchange. Example, he will be able to post from one place, instead of visiting each social network and making each post separately. With Socxs, he will be able to aggregate and create a LiveEvent based on his or his company's subjects of interest. Socxs enables the campaign manager to cross promote across any number of these social media, market to the users selectively in the social networks most appropriate for the users. The campaign manager can create a LiveEvent whereby there users and fans can further take his media to any websites. The manager will have a LiveEvent whereby all interested parties, whereby internal or external to his company—such as employees, customers, and the public—can share their experience and media. The stats from all the social networks are tracked within a unified Socxs framework so that the campaign manager will be able to further analyze the stats data for trends and results.

### IV. White Labeling

This is a white labeling of Socxs, whereby Socxs will provide its service to a third party organization.
What?
   Each white label instance will have its own exchange system that is not shared with another white labeled instance
   Bridge organization media and user account system with media and users on social networks
Why?
   Media: It's a Social Exchange System for the organization's media that can be use in creative social campaigns, whereby media can be freely shared across social networks.
   User: It's a Social Exchange System for the organization's users. It identifies and map the organization's users to the users across the social networks, creating a Unified User Profile for the organization
      Example, if she's ‘Linda’ at the organization's user base, we can map her to ‘Linda Smith’ on Facebook, ‘ilikecookies’ on Twitter, etc.

### V. Usage of Socxs

Campaigns:
   Delivery: It's a platform to deliver campaigns for loyalty, branding, marketing, products, PR, promotion, etc
   Customization: Create targeted campaigns to the users based on their provided information in the Unified User Profile.
   Outbound: Push out social campaigns to any number of social networks.
   Inbound: Aggregate the social streams back into a page to promote the company, brand, product, campaigns, etc. Aggregate social streams back to monitor activity, gain understanding, from a customized perspective.
   Widgets: Port any of the LiveEvents contained in a channel anywhere . . . but they are still centrally managed and tracked.
   User Demographic: Create media that are surveys to better understand the users across the various social networks.
   Viral: Easily start viral marketing using Socxs Channels across the various social networks.
   Events: A system for running campaigns for events where time is critical and relevant for only a short period, such a political campaigns, tradeshows, festivals, product introductions, etc.
      The system enables creation of Social Sites in real time that contains information and social content.
      It also brings together the community of users for the event.
      It's the one place where the users can see all, share, and exchange information about the event.
Social App and Games:
   The system is an infrastructure for building Social Apps and Games.
   The social apps and games built on our infrastructure engages users across not just Facebook, but also users across
      Socxs Network
      Enterprise Network base
      Other social networks, such as Twitter, YouTube, etc.
      Mobile Devices
Socxs Hierarchy of Social Exchanges
   There will effectively be exchanges that are Socxs and white-labeled Enterprise ones (based on the Socxs platform). Hence, it's a hierarchy of Social Exchanges.
   Promoting within exchanges
      Within Socxs own Social Exchange System
      Within White Labeled Enterprise owned Social Exchange System
   Promoting across exchanges
      However, there is an opportunity to cross promote across Socxs and the other White Labeled Enterprise Social Exchanges.

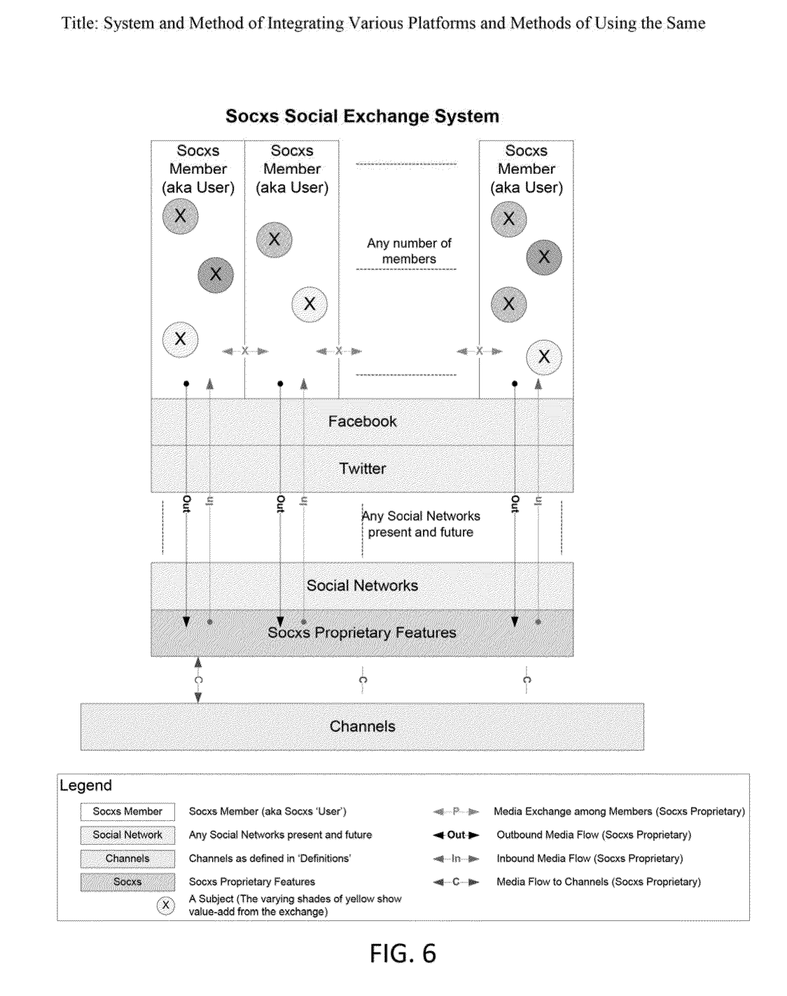

An overview of an example of a Socxs social exchange system is shown in FIG. 6. Figure six shows a series of exemplary Socxs members (or users), with three members specifically shown in the figure and represented in respective vertical columns. Represented in horizontal rows (or layers) are exemplary social networks such as Facebook or Twitter. Also shown is a horizontal row for a Socxs network which may have similarities or differences in capabilities from those of the pre-existing or future social networks shown. Also shown is a horizontal block representing “channels”. FIG. 6 includes a reference Legend as shown.

### Example 3

Example 3 is described in conjunction with FIG. 6. The Socxs system of FIG. 6 enables the following effects. One outbound media flow action changes all the layers, or in other words one media flow action can publish into all the layers (that have been selected automatically or by customization for the Supersite or the particular user. One Socxs dashboard can see all inbound media flow and enable the user or operator to respond. In some instances a user direct response is of course not needed as the Socxs system can be configured to operate or respond automatically and/or according to rules. The rules may be custom defined or default according to a variety of factors such as particular social network, identity of members, characteristics of members, characteristics of inbound or outbound media, timing of inbound media, traffic “density” or activity of certain social networks, groups. Importantly, the Socxs system can also apply rules to inbound or outbound media flow based on factors beyond the above factors. For example, the Socxs system can apply rules wherein inbound or outbound media flow is based on what is termed “outside factors”. In some cases the outside factors are events or characteristics not particularly unique to the member or social network characteristics. Examples of such outside factors include thresholds or changes in factors such as weather, cataclysm, sports event developments, financial market developments, political news, or other factor. The nature, degree, relevance (including to particular members or social networks) of the outside factors can be automatically applied via rules to filter, decelerate, accelerate, highlight or otherwise affect inbound or outbound media flow.

In Example 3 the Socxs system provides collective metadata integration across network metadata designs to provide an exchangeable structure that can be valuably shared among Socxs members (users) including shared into Supersites and targeted social networks (e.g., for facilitation of outbound media flow.)

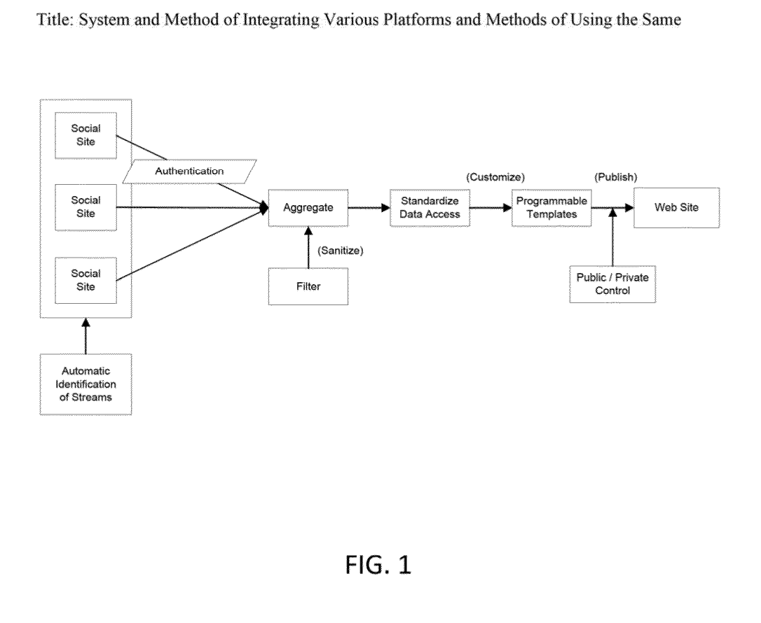

FIG. 1 shows aspects of an example of a method of aggregating and publishing media according to certain embodiments of the present invention. This method is merely exemplary and is not limited to the embodiments presented herein. This method can be employed in many different embodiments or examples not specifically depicted or described herein.

Shown in FIG. 1 are one or more exemplary social sites, an authentication step, procedure or process, an aggregation step, procedure or process, including a filtering option, a data standardization step, procedure or process, customization steps, procedures or processes, implementation of various levels of public, private or other controls, and publication steps, procedures or processes of various types. These general steps, procedures and processes are described in greater detail below, including the citation to various exemplary embodiments of various aspects of the invention.

The method of FIG. 1 includes a procedure of Identification of Streams, which in some embodiments can be an Automatic Identification of Streams. In this embodiment the SOCX system will automatically identify the internet accessible “Streams” that SOCX can process and integrate. This feature and capability greatly simplifies the integration of Social Media for the non-technical user. The explanation below exemplifies the capabilities of an embodiment of the Socxs system for an exemplary “user” of Socxs to, among other things, identify source streams, authenticate, aggregate and eventually publish data from the stream or otherwise provided by the user or other parties as shown in FIG. 1.

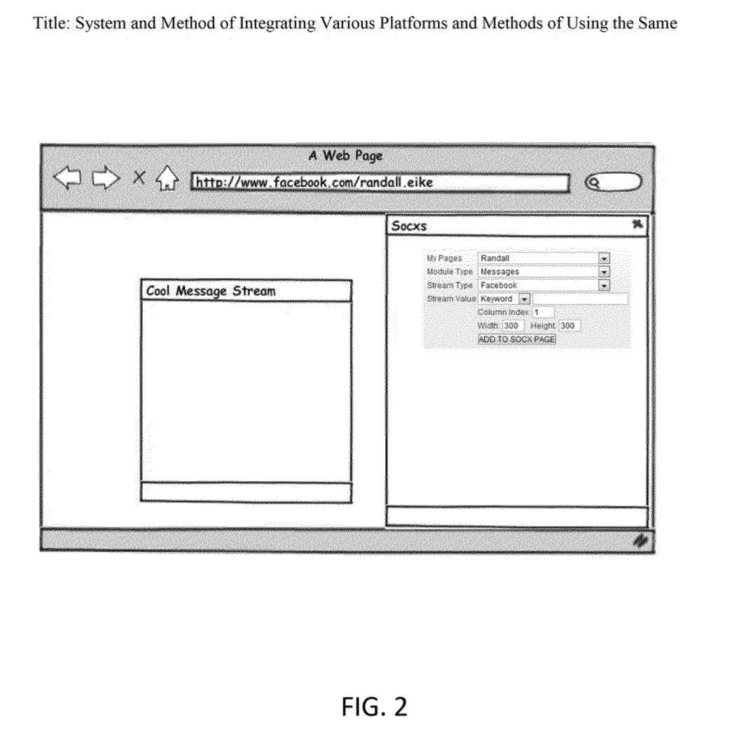

In some embodiments the following capability is provided at the beginning of the process shown in FIG. 1. As an example, if a user is browsing the web and finds a page on a Social Network with some interesting conversation or content (or other content that the user would like to use or publish), the user can simply click on the SOCX system's Bookmarklet and a “SOCXs” module appears in the right gutter. This can be seen in the example depicted in FIG. 2, which is an example from an embodiment of the present invention.

After identification or selection of the Social Network, a Socxs module will access the identified or selected URL and identify the “streams” from the URL that the Socxs system will or can process and integrate. This greatly simplifies the integration of social media for non-technical users of the Socxs system. Socxs can automatically identify the information necessary for Socxs to pull the Stream into Media Gate (described below) and even add it to a module on a page all in one action. A module is an area on a page that reflects content from one or more networking platforms.

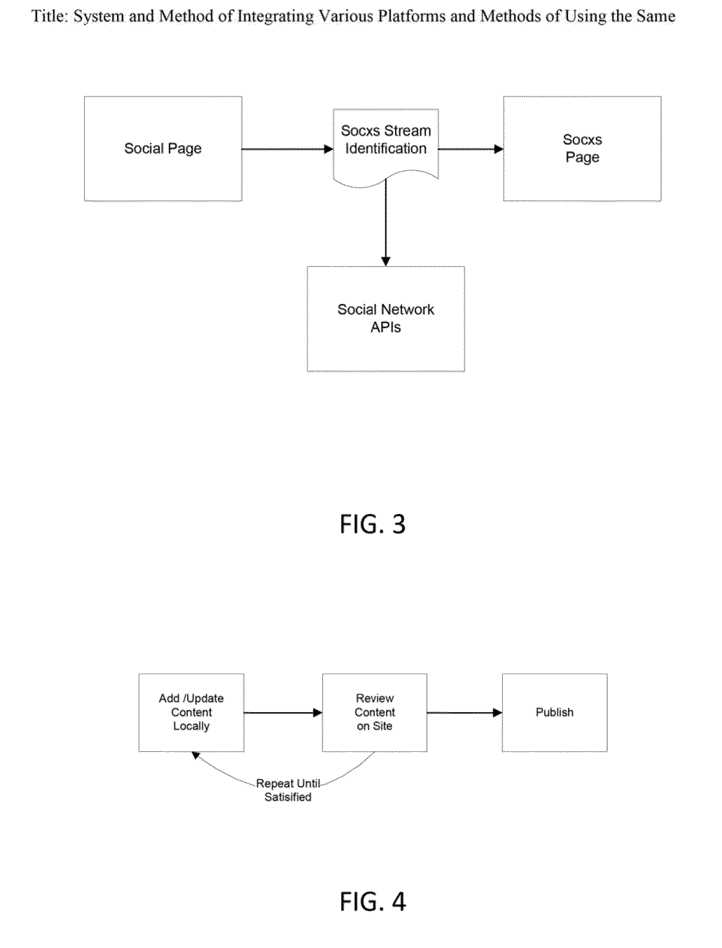

With reference to FIG. 3 (an example from an embodiment of the present invention), the Socxs Stream Identification system pulls information from the page and understands how to map that information to and/or from the Social Network's APIs. In some embodiments each Social Network that selected by a Socx user may be integrated into the Automatic Id lookup. The system looks for specific known patterns in the URL and page. When the system finds the patterns, it maps them to Stream types the system supports and the logic the system needs to pull the data from the backend APIs. The system presents them to the user to select which “Stream” the user may want to include.

Next, the method of FIG. 1 includes a procedure of Authenticating. During the Authenticating procedure, the system collects and manages multiple “Authentications” for users and uses that to retrieve content from the Social Sites.

Subsequently, the method of FIG. 1 includes a procedure of Aggregating. Aggregating includes pulling content on demand for use from a site, which can be public or non-public.

Then the method of FIG. 1 includes a procedure of Sanitization. The system offers the ability for owners to review and Filter content, i.e., approve/reject it before (or after) pushing to the site. This procedure can be an optional one.

Next, the method of FIG. 1 includes a procedure of Standardizing. During standardization, the system pulls content from disparate networks with disparate APIs, formats, and data and puts them into a standardized set of “Steam” types. As an example, this enables the user to quickly and easily integrate Flickr, Picasa, and Facebook photos feeds, even though their backend APIs are totally different and return different attributes.

Furthermore, the method of FIG. 1 comprises a procedure of Customizing. During customization, the standardized data sets are then available to the SOCX Programmable Template Scripting engine which. Generally, this is a scripting language that allows the user to layout her selected content in a whatever fashion she may elect or desire. They can provide better and more interesting user interfaces for the content and seamlessly integrate it into their site.

In addition, the method of FIG. 1 includes a procedure of Public/Private Control. The system offers the user a fine tune control about what content is to be displayed. As an example, a user can set the level of control to personal, organization only, or public. It should be noted that more or less levels of control can be used.

Next, the method of FIG. 1 includes a procedure of Publishing. The system pushes the output to a public facing web site.

In other embodiments, a method and system for improving web content management with automatic file synchronization is presented. This method and system is merely exemplary and is not limited to the embodiments presented herein. This method and system can be employed in many different embodiments or examples not specifically depicted or described herein.

In this method, a user can download a client program that runs locally which sets up a shared folder between the user's computer and the user's Socxs account. Whenever a user creates a Freeform module, the program creates a corresponding folder on the user's computer in his or her SOCXs folder. Then the user can simply edit files in their local folder and they get automatically synced with the SOCXs module. Users can use their regular web tools and see their changes reflected on the site almost as soon as they click save. The user doesn't have to worry about zipping up files and uploading them into MediaGate. Likewise for background images, it is much more convenient to drag an image to a folder than to have to upload it into MediaGate. And for images in some embodiments, the Socxs system applies rules to automatically generate different web read sized images from the original.

FIG. 4 depicts an example of the workflow of the system. This system and method are more efficient from previous systems. As an example, the system saves time because content is already on the contributor's local computer (i.e. don't have to wait if large files are involved), eliminates file version issues (where someone would overwrite someone else's change because they didn't download all changes), and simplifies the process (no need to “login” to a CMS system.)

Additional components of this system can include, for example: subscribing to web site sections and only those sections are synchronized to a user's local drive, notification system (if someone changes files in a section in which a user is subscribed, the user gets a notification), automatically generate “web ready” assets from assets uploaded (based on users configured profiles—as examples, thumbnails and multiple sizes images from the original and encode video to various codec/bitrates for web delivery and select key frames for a thumbnail), and more fine tuned auditing information (for example, it is easy to track and remember every version of every file that is changed.)

In addition, a method and system of stream retrieval and caching is presented. As an example, this can be a system and method for determining when a particular module should be populated with new data, or whether the current data is good enough to display in the module. This method and system is merely exemplary and is not limited to the embodiments presented herein. This method and system can be employed in many different embodiments or examples not specifically depicted or described herein.

Embodiments of the present invention may comprise all or only portions of the steps or methods described in the exemplary descriptions above.

### Example 4

Example 4 outlines a typical user experience and capability in one Socxs embodiment of the present invention:

1. User
Sign Up: User A, say ‘John’, sign ups for a Socxs page, called a Socxs LiveEvent
Set Up: John sets up his LiveEvent for a Subject using Socxs Dashboard, via the following process:
   Authenticate with Social Networks: He established links and authenticates with Social Networks:
      As an example, he chose to authenticate with Facebook, Twitter, YouTube, Flickr, Picasa, MySpace, LinkedIn, Blogs, Digg, RSS, Socxs proprietary, and more
   Stream Discovering: Using Socxs, he proceeds to discover the streams he wants to add to his LiveEvent, using a Socxs Stream Discoverer (Stream Lookup) feature.
   Collective Streams: John will discovers and add his ‘Collective Streams’ for his LiveEvent using Socxs Dashboard
   Filter: He can add filters based keywords, dates, names, favorites to drill down his collective streams
Customize: John proceeds to personalize his LiveEvent—layout, skins, messaging, and content using Socxs Dashboard
Media Pull: Socxs will pull the media for John's collectively stream dynamically
Media Post:
   John will be able to post outbound media to all the social networks and Socxs. John one outbound media action dynamically changes all the layers (all the social networks and Socxs).
Publish into Channels:
   Socxs publishes John's LiveEvent automatically into the Channels.
Tracking and Tagging:
   Tracking. Socxs will automatically tracks the collective social activities from across the many streams in the man social networks all into one convenient Socxs Dashboard. (Social activities are stats such as number of posts, comments, messages, media exchange, file uploads, etc.)
   Tagging: Socxs adds a special Socxs tag o each piece of media to enable the system to discover the media across the various social networks.
Workflow:
   Schedule: John will also be able to schedule his posts and publishes into his LiveEvent
   Alert: He can create alerts to him when certain triggers are activated (by traffic, keywords, and/or events)
   Monitor: He can monitor the buzz/sentiment about a brand, product, interest, subject, etc. based on specific parameters

### Example 5

Example 5 outlines a possible “fan” experience in an exemplary Socxs embodiment according to aspects of the present invention.

Fans are basically anyone that are not the user, who is interested in the user and/or the subject matter of the LiveEvent Fans will be to post media to John's LiveEvent and it will appear in all these places:

a) All the social networks in John's Collective Streams

b) John's Socxs LiveEvent

c) The Fans' own social network pages.
Fans will be able to post media from all the Channels (please see Definition for Channels)

In additional embodiments of the present invention and in relation to Examples 4 and 5, when there is another Socxs LiveEvent, say it's set up by user ‘Jane’, Jane's LiveEvent will be able to have media exchanges with John's LiveEvent. Each exchange will add social value, coverage, and distribution. (This is the exchanges shown by the arrows marked with ‘X’) Also, with each exchange, Socxs can provide a unified user profile which can will identify each user and continually map each user across the social networks to create a Unified User Profile. Example, John could be ‘Doe’ on Facebook, ‘BigMan’ on Twitter, and ‘GoGetter’ on Google.

### Example 6

1. Example 6 sets out specifications for certain aspects of a particular embodiment of a Socxs implementation. Example 6 includes the following sections: Core Media Gate Features, Automatic Identification of Streams, Web Content Management via File Synchronization, and Stream Retrieval and Caching
   a. Automatic Identification of Streams—Basically, given a URL Socxs may automatically identify the “Streams” that SOCXs can process and integrate. This greatly simplifies the integration of Social Media for the non-technical user.
   b. Authenticate—collect and manage multiple “Authentications” for users and use that to retrieve content from the Social Sites.
   c. Aggregate—pull content on demand for use on public site
   d. Sanitize—Socxs can offer the ability to for owners to review and Filter content—approve/reject it before (or after) pushing to the site.
   e. Standardize—Socxs can pull content from disparate networks with disparate APIs, formats, and data and put them into a standardized set of “Stream” types. This enables the user to quickly easily integrate Flickr, Picasa, and Facebook photos feeds for example even though their backend APIs are totally different and return different attributes.
   f. Customize—these standardized data sets are then available to the Socxs Programmable Template Scripting engine. This may comprise scripting language that lets the user layout their content in whatever fashion they desire. They can provide better and more interesting user interfaces for the content and seamlessly integrate it into their site.
   g. Public/Private Control—offer fine tune control about what content is personal, organization only, or public.
   h. Publish—push the out to a public facing web site.

The automatic identification of Streams module may access the URL and the content of the page and automatically identify the information necessary for Socxs to pull the Stream into Media Gate and even add it to a module on a page all in one action

### Example 7

With reference to FIG. 3, Example 7 is an example of an implementation of a Socxs Stream Identification system according to aspects of the invention. The system pulls information from the page and understands how to map that information to the Social Network's APIs.

Each Social Network that is integrated has to be integrated into the Automatic Id lookup.

The Socxs system can look for specific known patterns in the URL and page. When Socx finds the patterns, it can map them to Stream types it supports and the logic needed to pull the data from the backend APIs. They are presented to the user to select which the “Stream” they want to include.

### Example 8

### Enhanced Mediagate Implementation

In MediaGate, a user can download a client program that runs locally which sets up a shared folder between the user computer and the user's SOCXs account. Whenever you (the user) create a Freeform module, the program creates a corresponding folder on your computer in your SOCXs folder. Then the user can simply edit files in their local folder and they get automatically synced with the SOCXs module. Users can use their regular web tools (e.g. Dreamweaver) and see their changes reflected on the site almost as soon as they click save. They don't have to worry about zipping up files and uploading them into MediaGate. Likewise for background images, it is way more convenient to drag an image to a folder than to have to upload it into MediaGate. And for images we could also put rules in place automatically generate different web read sized images from the original.

### Example 9

### Additional Embodiment Features

a. Workflow

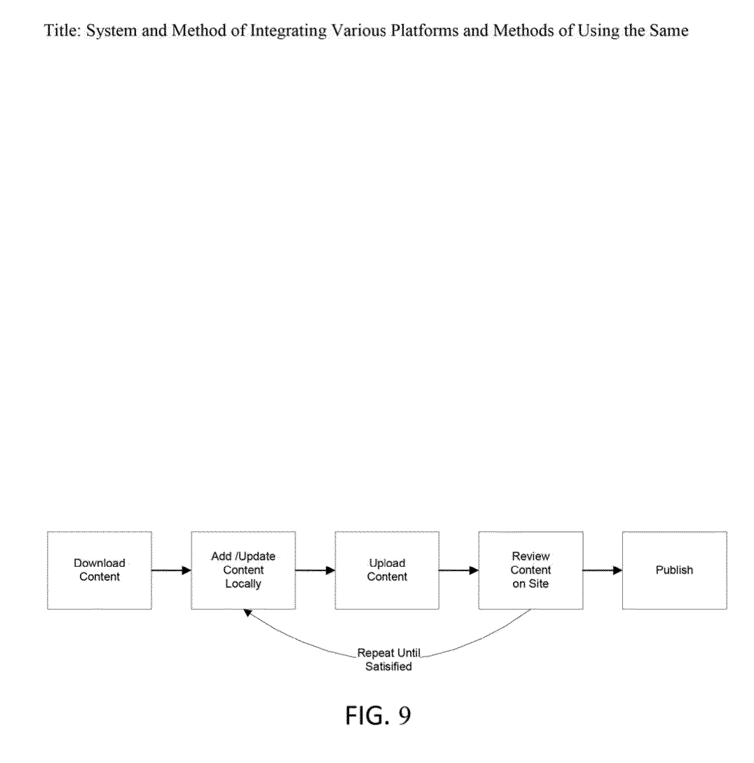

An example of a workflow of traditional CMS systems is shown in FIG. 9.

An example of a Socxs workflow is shown in FIG. 4.

This is a huge efficiency gain from the content contributor point of view:
Removes manual steps from the process.
Saves time because content is already on the contributor's local computer (i.e. don't have to wait if large files are involved).
Eliminates file version issues we often had—where someone would overwrite someone else's change because they didn't download all changes.
Simplifies the process—no need to “login” to a CMS system.

b. Components

Additional components to the system
Subscribe to web site sections and only those sections are synchronized to your local drive.
Notification system—if someone changes files in a section you are subscribed, you get a notification (perhaps for review)
Automatically generate “web ready” assets from assets uploaded (based on users configured profiles)
   Thumbnails and multiple sizes images from the original
   Encode video to various codec/bitrates for web delivery and select key frames for a thumbnails.
More fine tuned auditing information (i.e. it is easy to track and remember every version of every file that is changed)

### 2. Other File Synchronization Examples

On the file sync side, many companies are starting to think about this for specific services, but we have not seen any. Here are a couple examples:

### Box.Net:

Embed any Box file on a website
Embed instantly viewable files on your website. Select the new option “Embed File in Your Site” in the actions menu, which automatically generates HTML code you can copy and paste. People can scroll through your documents and other files in an instant.

This is different from what we are doing—they are offering a convenient way to share documents on a web site, not a mechanism to manage your site.

### Encoding.Com:

Watch Folder
Easily setup Watch Folders and encoding profiles in the Encoding.com client interface to check your source media location (SFTP/FTP/Amazon S3 or Rackspace CloudFiles) for new videos at any time frequency. New files added to your Watch Folder are automatically encoded to your set encoding profile, and delivered to your desired destination (SFTP/FTP/Amazon S3 or Rackspace CloudFiles).

This is not on the user local hard drive and not for web content management.

As an example, the following can be a set of guidelines that are used to help determine whether the system should wait for new data to be displayed in a module, or whether the current data in cache is good enough to be displayed in a module.
1. Always populate a module with “something”; a module should never be empty.
   a. It is better to show old data than no data.
2. Always deliver the page to the user in a timely fashion; such as, for example, less than 5 seconds. It should be noted that any other period of time can be used.
   a. As an example, for 5 seconds, never wait more than a total of 4.5 seconds for an external call to complete. It should be noted that any period of time can be used here also.
3. If it we can't deliver up to date data for a given request, still attempt to have that data available for future request.
4. Be robust in the face of failure to pull data:
   a. Don't constantly retry over and over, but also don't give up trying to get failed data in a reasonable period. Strike a balance.
   b. When it fails, continue to deliver the stale data.
5. Have the ability communicate to the end user
   a. The timeliness of the data that we do present to them.
   b. Errors in pulling data when they do occur.
6. Don't over-pull data. If one request is causing a stream to be pulled, another request should invoke the same external requests but rather should piggy back on the original request.

Furthermore, the following are examples of relative states of cached data:
1. Current—the data in the cache is considered current and we simply return it to the user.
2. Semi-State—the data is fresh enough to immediately return to the user, but we should refresh the cache of data we have.
3. State—the data is out of date, we should attempt to get fresh data for the user.

It should be noted that more or less freshness states can be used. In addition, different freshness states of data can be used.

In addition, data can have error states. The following are examples of error states:
1. No-Error—everything is smooth; no problem
2. Refresh-Timeout—the last attempt to refresh the data timed out
3. Refresh-Failed-External—the last attempt to refresh the data resulted in the external provider returning a service error (i.e. they did not send valid data)
4. Refresh-Failed-Internal—the last attempt to refresh the data resulted in an error processing the returned data

It should be noted that more or less error states can be used. In addition, different error states of cache can be used.

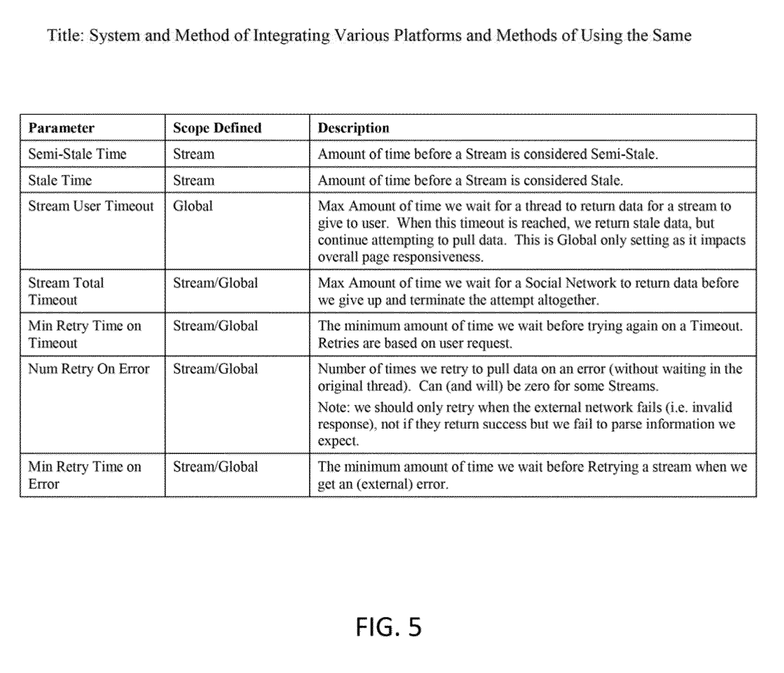

FIG. 5 depicts examples of parameters that are relevant to the data caching system. It should be noted that more, less, and/or different parameters can be used.

Also presented is a method for using the system and method of aggregating media. This method is merely exemplary and is not limited to the embodiments presented herein. This method can be employed in many different embodiments or examples not specifically depicted or described herein.

The following are examples of the capabilities of the method and system of aggregating media (Socxs).

Centralized Management:

Socxs provides a single dashboard, called MediaGate, to allow non-technical users to manage their social content, social users, and social campaigns all in one convenient location using simple user interface. In addition, the system can allow that there be a hierarchy of users. In one example, there are different permission levels to limit user access (read and/or modify) to pages.

Aggregation:

Socxs provides an ability to aggregate data from a variety of different platforms. As an example, you can have collective streams. A user can specify her ‘collective streams’, which become the base collection of streams. This allows the system to authenticate, pull, post, and track.

In addition, Socxs can authenticate users. As an example, Socxs can manage authentication collectively across a user's aggregated streams to all the user's social networks.

Furthermore, Socxs can pull data. As an example, the system can pull social content as ‘streams’ from social networks into modules in social web pages. Each social web page can have any number of these modules. Each module can have any number of streams. Each module can have a combination of different streams from different social networks, based on the type of content

Furthermore, Socxs can enable posting of data. As an example, the system allows a user to post back to the collective streams across the many social networks from one place.

In addition, Socxs can enable tracking of data. Similarly, the system tracks the collective social activities from across the many streams in the many social networks all into one convenient location. Social activities are stats such as number of posts, comments, messages, file uploads, etc.

Also, Socxs allows a user to manage streams. As examples, a user can manage stream s by URL, that is the system provides a simple method to add streams into the system. The user specifies only the URL and it is added to the system. In addition, a use can manage stream by bookmarklet. A bookmarklet enables a user to add streams into the system in real time while browsing on the social network pages.

Customization:

Socxs provides a user with the ability to customize her page. As an example, a user can customize a webpage (its layout, skins, content, etc.) In one embodiment, Socxs allows a user to create non-social content modules. In the same or other embodiments, users can point, click, drag, and drop to add/delete modules and change module placement (e.g, move, span, and/or adjust size.) In yet other embodiments, with Socxs a user can used a simple UI to change the page and module colors and a simple upload to add background image. Furthermore, in more embodiments, Socxs can contain a unique templating system that allows more advanced users to specify data structure, content type, and styles for each module.

Republish:

Socxs allows a user to republish data from networking platforms. As one example, Socxs provides a customized social website for public viewing. In another example, a simple UI can be used to point and click to publish the data. In yet more examples, users are allowed to preview changes. In one embodiment, changes that are made to a webpage are not available for public viewing until the user clicks on the publish button.

In some embodiments, there are different privacy levels that can be set for each page, or even module. In one example, there is a flag to turn a page or module on or off from being public. In some embodiments, the private setting requires login access.

Furthermore, in some embodiments, Socxs allows each social page to be optimized to so it is easy for search engines to crawl and index.

In some embodiments, the method of using the system and method for aggregating data can vary for the type of users. Examples of different types of users include enterprise users, small business users, and individual users. It should be noted that more, less, or different users can be included.

In one example, the user is enterprise users. Enterprise users are allowed the greatest range of access to the system. Each Enterprise Network will have its own user database that is not shared with another enterprise network's user database. The Socxs system can be used to bridge enterprise account system with accounts on social networks to enable customized marketing campaign for the enterprise. In addition, the system can be used to integrate enterprise's own user community with the community on social networks. As a result, the user can identify and map the enterprise's users to the users across the social networks. As one example, the user can determine that one individual has a user ID of ‘Kratos’ at the company user base, and has a user ID of ‘John Smith’ on Facebook, and ‘ilikegames’ on Twitter, etc. The Socxs system is a layer above all the social networks account systems that maps and integrates users in the social networks to the enterprise's own user base.

This type of information can be used for a variety of purposes. For example:
Survey System: Add social surveys to capture user information that is customizable to the enterprise's markets and requirements.
Social User Database: The Socxs system can build a database to store user mapping and user information
User Dashboard: There is a dashboard to allow business users to create reports and queries the Social User Database.

As another example, the method of using the system and method of aggregating data can comprise a procedure of creating campaigns. As an example, campaigns can include:
Delivery: It's a platform for enterprises to deliver campaigns for loyalty, branding, marketing, products, PR, promotion, etc
Customization: Create targeted campaigns to the social users based on their provided information in the User Database.
Outbound: Push out social campaigns to any number of social networks.
Inbound: Aggregate the social chatter back into your domain fully customizable Social Sites where the enterprise can further promote the company, brand, product, campaigns, etc.
Widgets: Port any of the modules anywhere, but they are still centrally managed and tracked.
Events: A system for running campaigns for events where time is critical and relevant for only a short period, such a political campaigns, tradeshows, festivals, product introductions, etc. The system enables creation of Social Sites in real time that contains information and social content. It also brings together the community of users for the event. It's the one place where the users can see all, share, and exchange information about the event.

As an example the enterprise can use Socxs to: schedule posts, schedule publications, alert business managers when specified triggers are activated (such as, for example, by traffic, by keywords, by events, etc.), monitor the buzz/sentiment about the brand, product, interest, etc based on specified parameters, filter out streams based on provided keywords, or combine any of the above elements to create more sophisticated business rules, such as you can set a ‘monitor’ with an ‘alert’.

In other embodiments, a user can use Socxs to access mobile markets. For example, a user can bring the Social Sites as mobile sites or apps accessible from ‘mobile devices’ (such as, but not limited to iPhone, iPad, Android, etc.), convert each module into tabs that fit and are optimized for the mobile devices, and enable content managers to create content, post, and publish them through the system from the mobile devices.

Furthermore, in other embodiments, a user can create social applications and games. The user can use the system as an infrastructure for building social apps and games. As an example, the social apps and games built on Socxs infrastructure engages users across a variety of social platforms (i.e., not just Facebook, but also users across Socxs Network, Enterprise Network base, other social networks, such as Twitter, YouTube, etc., and mobile devices. It should be noted that any other social platform can be included.)

In addition, it should be noted that various users can use Socxs to cross promote across Socxs networks and/or enterprise networks.

In other embodiments, Socxs technology creates an aggregation of searches and their results across all social networks, publicly available content, and search engines.

As an example:

1. The Socxs technology provides the functionality to do a Socxs Search.

2. A user enters the keywords to search/filter terms used by the Socxs Search.

3. The Socxs technology enables the keyword search across all the different social networks and predefined relevant publicly available data.

4. The Socxs technology then aggregates the search results.

5. The MediaGate technology publishes back a web page dynamically with the aggregated results of the search.
i. It's a new representation of search displayed in a Socxs Supersite webpage.

In other embodiments, Socxs ‘Media Connections’ page is a web page, built dynamically from the relationships in Facebook Social Graph. For example, a user can simply enter a Facebook page of interest and Socxs will create an aggregated web page based on the relationships in the Facebook Social Graph. The Socxs technology will read a Facebook Social Graph and give the user a full representation of what the page will contain in terms of content, media, and with the modules fully aggregated. As an example:

1. User enters a Facebook page

2. Socxs reads the relationships within Facebook Social Graph

3. Socxs technology automatically builds a page that aggregates the content from all the sources within the Facebook Social Graph relationships. In other embodiments, ‘Anything-You-Want’ page is a hybrid page that is a combination of any the following examples:
Customized pages and modules
Socxs Search Aggregation
Socxs Social Graph Pages

It should be noted that further examples not specifically mentioned here can also be included.

In other embodiments, an integrated mobile strategy can be included. Examples of components of an integrated mobile strategy can comprise:
Automatically Generated
   It's basically a fully customized mobile version of the Socxs frontend web page that is automatically generated with no extra work.
   It will be accessible from browser app of mobile devices
   Applications can be developed, to be downloaded onto iPhones, Android and other smart phones which enable mobile application to be accessed directly from an icon on a phone. These applications would launch Socxs pages.
Mobile Browser
   Auto detect the phone mobile browser and display the mobile version instead of the regular version
One module per screen per load
   Instead of displaying the current regular 1024 version all at once, break up the display one module at a time.
   Hence, at any point on the screen, there should only be one module displayed. Each screen is exactly the one module from the Socxs page.
Module size
   The size is optimized to fit into the mobile screen.

In other embodiments, Socxs enables pages and modules to be shared easily. The Socxs system automatically adds the sharing functionality to every Socxs page and module. All visitors to the Socxs page can share the content. For example, even if they don't have MediaGate access to the page, they can still share the page content. Generally speaking, if the page is public, the page content can be shared.

This will enable businesses to easily start a Social, Viral, and Click Marketing campaign, enabling ‘Anyone-to-Anything-to-Anywhere’, making the campaigns ‘Live, Viral, and Relevant’ via Socxs ‘AnyAppWhere’.

The system can also capture the data and statistics when users share Socxs content. As examples, the following can be tracked:
Who is the user?
What did the user share?
What are the Source and Destination pages?
How many times the user shared the Socxs content?

The following are 3 examples for sharing page content via ‘AnyAppWhere’:
Page Info
   For sharing the page info in Facebook, Twitter, email, etc.
Modules
   The Socxs system automatically creates code for every module on the page.
   When visitors embed this code into their own website, it'll automatically recreate the module. This module is updated with live data every time the page is refreshed.
   This code is made available to visitors on a Socxs page and on each embedded module.
   The modules embedded into a non-Socxs domain are still fully functional and interactive as it would be on the Socxs page.
Facebook Tab
   A Facebook version is automatically created for each Socxs page in a few clicks.
   Any visitor to the Socxs page will be able to take the Facebook version of the Socxs page and add it as a Socxs Tab to their Facebook Page.
   The Socxs Tabs on Facebook are still fully functional and interactive as they would be on the Socxs domain pages.

In other embodiments, the present invention can comprise a social and viral CRM. For example:
A new Socxs module type that enables capturing of CRM information about the user, profile, demographic, geographic, promotions, etc.
With media sharing the modules can be shared anywhere on anyone's web page whether it's created by the page owner or not, whether on Socxs domain or non-Socxs domain.
These Socxs CRM modules will be critical in building a single unified profile for capturing user data across social networks on any pages they are embedded in.

In other embodiments, new module types can be created. In some examples, new modules types created will automatically inherit the ‘AnyAppWhere’ functionality so that they can all be shared by anyone and anywhere. Examples of modules include:
Media (Video/Audio) Stream type
Rating and Review module type
Polling and Survey module type
Sweepstakes module type
Registration module type
Social Graph module type

In other embodiments, the Socxs platform can create a destination for all things gaming: such as, for example, game data, social media (messages, photos, videos, news, fans, blogs etc.), marketing messages, ads, and more.

Further examples of embodiments include:
MediaGate
   It's the technology that allows users to define their social media streams and create pages, provided by Socxs Technologies Inc. (“Socxs”)
Supersites & Super Communities
   A ‘Supersites’ or ‘Social Supersites’ are sites published using Socxs technologies to represent a subject or a social view that is an aggregation of content from the many social networks as well as other publicly available sources of content.
   A ‘Super Community’ is the user base from across multiple social networks that Socxs brings together as a single unified profile or community view.
‘AnyAppWhere’ for ‘Anyone-to-Anything-to-Anywhere’
   We are coining the term ‘AnyAppWhere’ as Socxs is an interactive platform for building Supersites that unifies social media from Facebook, Twitter, YouTube, Flickr, RSS, Blogger, Picasa and more around a subject matter, enabling a many-to-one publishing around a subject or subjects. It then flips the process, enabling a one-to-many viral distribution of Supersites.
   It's essentially an ‘AnyAppWhere’ for making ‘Anyone-to-Anything-to-Anywhere’ happen so that social campaigns are ‘Live, Viral & Relevant.’
‘Search Collections’
   Socxs technology that creates a web page that is an aggregation of Searches and their results across all social networks, publicly available content and search engines.
‘Media Connections’
   Socxs Media Connections page is a web page, built dynamically from the relationships in Facebook Social Graph.
‘Anything You-Want’
   An ‘Anything-You-Want’ page is defined as a hybrid page that is a combination of any the following:
      Customized pages and modules
      Socxs Search Aggregation
      Socxs Social Graph Pages

Live App

The following is an example, as illustrated in Appendix 5.

Objective
Create a companion app that allows users to capture and post messages, photos, and videos into their social networks and ultimately back into their Socxs pages.
Enable the app to allow users to capture as fans for organizations social streams.

What does the App do?
Access/view My Pages: user's page and other organization's pages (Live Events)
Capture/post messages, photos, and videos to both the user's own account page and other Socxs organization's pages

Live Capture
Personal:
   This is basically the post tab
   Allowing user (account owner) to capture and post into his/her own social network or Facebook pages, just as in the Post tab.
Organization:
   Allow users, fans, and account owner (everyone) to capture and post into the organization page
   Update the userid and keyword tags automatically based on MediaGate aggregated streams
   Add a flag to allow admins to exclude/disable it from the App

App Flow
In order to make the app simple, it may be desirable to not be multiple steps and pages.
   In fact, in one example there is only 1 main page and that's ‘View Page’.
   And, you can switch easily between your personal and other organizations' View Page'.
   The other page types are for Sign In and Sign Up.
The list of pages and flow are below:
   View Page
   Sign In/Sign Up selection
   Sign In
   Sign Up
   My Streams (Quick Add)
In order to use the app, i.e. to get to ‘View Page’ screen, users will ALWAYS need to be SIGNED IN.

Screens
Browser vs. App:
   There are 2 ways to access a Socxs page from a Smartphone:
      Browser:
         This is what we have today with ‘www.socxs.com/ . . . ’ changed to ‘m.socxs.com/ . . . ’
         From the browser, users can only view the page and not capture, sign in, add streams, etc, as with the app.
      App:
         The app will allow users to view, capture, share, add streams, etc, per the screen below
App Screens:
   My Pages:
      That is just View Page for the user's own account page and all the pages that he/she has admin access.
   Share:
      This is similar to the Post tab in MediaGate, which allows you to add messages, photos, and videos.
      Messages:
         Post to only one Facebook or Twitter stream in the aggregated list
      Capture (the camera icon):
         Select whether it's video or photo to add to the social network destination
   Live Events:
      Clicking the nav icon:
         This is just a list of events that users can post to.
         Users can also search the list.
      Selecting an Event:
         It'll launch View Page for the organization with the Share functionality for the particular organization.
   My Streams:
      This is just the Quick Add overlay fitted in the mobile screen.
   Bookmark:
      Allow you to bookmark Live Event pages that you are interested in.
      Once bookmarked, the Live Event pages can be found in the menu.

Appendix 6 is illustrative of another exemplary embodiment of the present inventions.

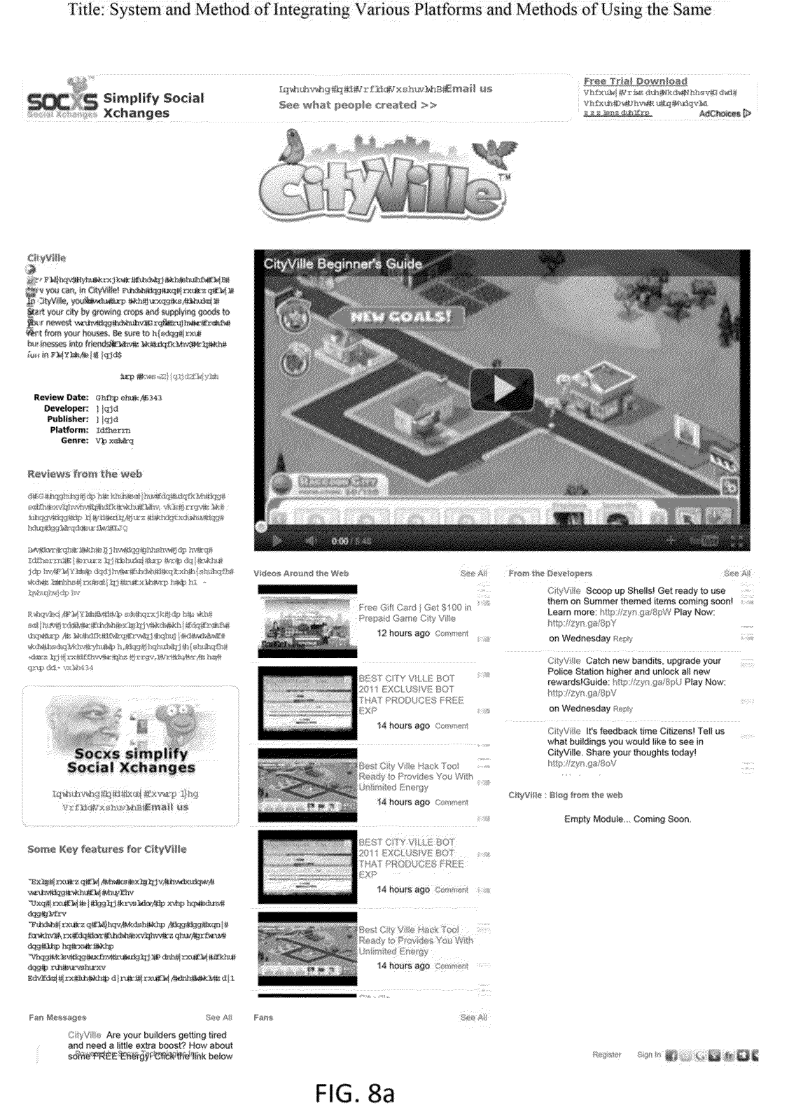

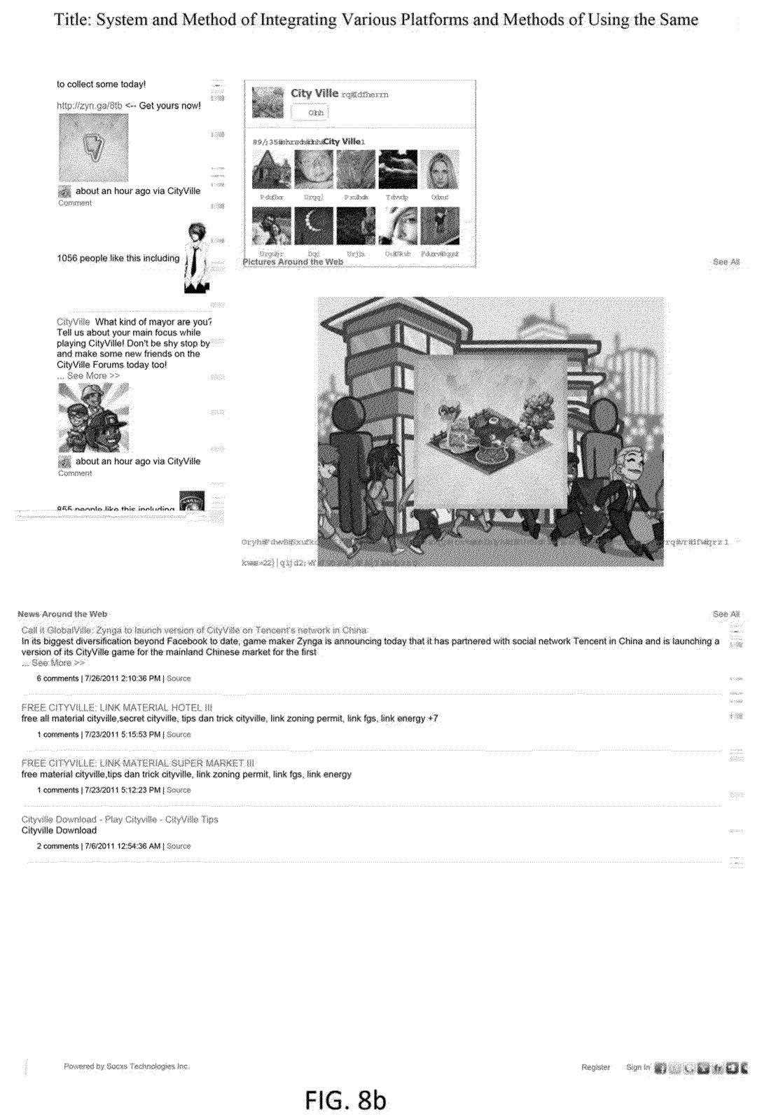

The viewer experience for LiveEvents or Supersites can be custom designed by the administrator of the LiveEvent or Supersite. As described herein content from various feed stream sources can be aggregated in custom designed and grouped format including with additional artwork and characteristics not drawn from feedstream sources. Examples of actual Socxs LiveEvent pages are shown in FIGS. 7 and 8.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the systems and methods discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

For simplicity and clarity of illustration, the figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of a first electrical device being coupled to a second electrical device does not mean that the first electrical device cannot be removed (readily or otherwise) from, or that it is permanently connected to, the second electrical device.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a system for aggregating data.

2. A method comprising:
aggregating data.

3. A method comprising:
using a system of aggregating data.
